(19) United States
(12) Patent Application Publication
(10) Pub. No.: US 2024/0250278 A1
(43) Pub. Date: Jul. 25, 2024

(54) FUEL CELL STACK

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 18/410,226

(22) Filed: Jan. 11, 2024

(30) Foreign Application Priority Data
Jan. 20, 2023 (JP) 2023-007224

(51) Int. Cl. H01M 8/0273; H01M 8/0258; H01M 8/1004; H01M 8/2483

(52) U.S. Cl. CPC H01M 8/0273; H01M 8/0258; H01M 8/1004; H01M 8/2483

(57) ABSTRACT

A fuel cell stack includes stacked cells. Each cell includes a plastic support frame member that supports a membrane electrode assembly, and includes two separators that sandwich the support frame member. The support frame member and the two separators each have a through-hole that extends in a stacking direction of the cells and define a passage through which fluid flows. The support frame member includes a protrusion that protrudes from each separator in at least one of an outer edge of the support frame member and a peripheral edge of the through-hole. The protrusion is sandwiched by plastic frames in the stacking direction together with outer edges of the separators, peripheral edges of the through-holes of the separators, or both the outer edges and the peripheral edges.

### BACKGROUND

### 1. Field

The present disclosure relates to a fuel cell stack.

### 2. Description of Related Art

Japanese Laid-Open Patent Publication No. 2017-76512 discloses a typical example of a fuel cell stack. Such a fuel cell stack is formed by stacking thin plate-shaped cells. Each cell includes a plastic support frame member that supports a membrane electrode assembly. The cell also includes two separators that sandwich the support frame member.

In the fuel cell stack, the thin plate-shaped cells have a relatively low rigidity and are thus likely to be warped. Thus, stabilizing the cells in a stacked state is difficult.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fuel cell stack according to an aspect of the present disclosure includes stacked cells. Each of the cells includes a plastic support frame member that supports a membrane electrode assembly at a central portion of the support frame member. Each of the cells further includes two separators that sandwich the support frame member. The support frame member and the two separators each have a through-hole that extends in a stacking direction of the cells and define a passage through which fluid flows. The support frame member includes a protrusion that protrudes from each of the separators in at least one of an outer edge of the support frame member and a peripheral edge of the through-hole. The protrusion is sandwiched by plastic frames in the stacking direction together with outer edges of the separators, peripheral edges of the through-holes of the separators, or both the outer edges and the peripheral edges.

Other features and aspects will be apparent from the following detailed description, the drawings, and the claims.

### BRIEF DESCRIPTION OF DRAWINGS

FIG. 1 is a schematic cross-sectional view of a fuel cell according to an embodiment.

FIG. 2 is a plan view of a cell according to the embodiment.

FIG. 3 is an exploded perspective view of the cell according to the embodiment.

FIG. 4 is a cross-sectional view taken along line 4-4 in FIG. 2.

FIG. 5 is a cross-sectional view showing part of the fuel cell stack according to the embodiment.

### DETAILED DESCRIPTION

This description provides a comprehensive understanding of the modes, devices, and/or systems described. Modifications and equivalents of the modes, devices, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A fuel cell according to an embodiment will now be described with reference to the drawings.

### Fuel Cell 11

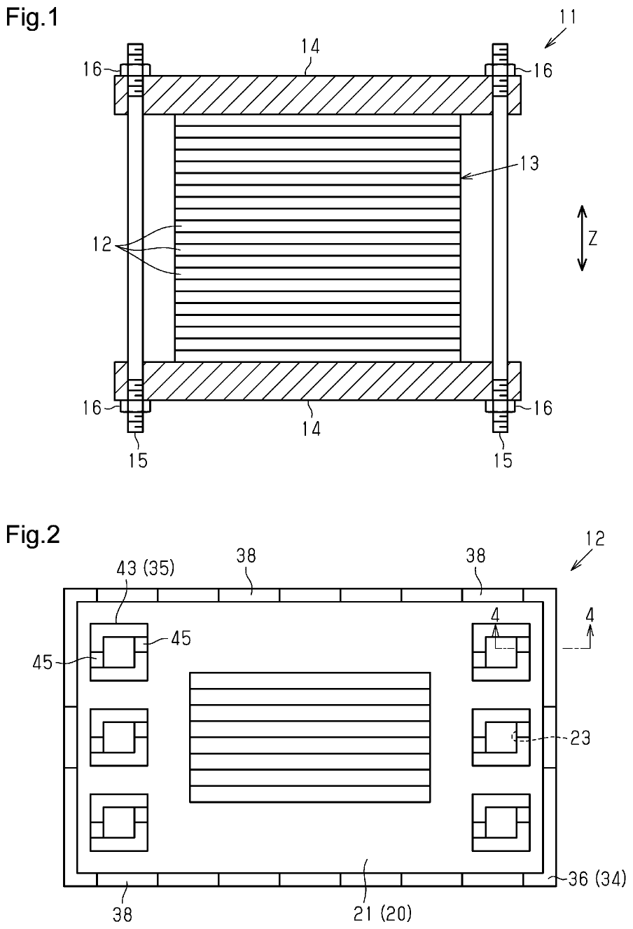

As shown in FIG. 1, a fuel cell 11 includes a fuel cell stack 13 and two end plates 14. The fuel cell stack 13 includes rectangular cells 12, each generating power. The cells 12 are stacked in their thickness direction. The two end plates 14 sandwich the fuel cell stack 13 from the opposite sides of the cell 12 in a stacking direction Z. The two end plates 14 are pressed so as to compress the fuel cell stack 13 in the stacking direction Z by fastening the outer edges of the end plates 14 using bolts 15 and nuts 16. A terminal plate (not shown), which collects current, and an insulating plate (not shown), which performs insulation, are arranged between the fuel cell stack 13 and each of the two end plates 14.

### Cell 12

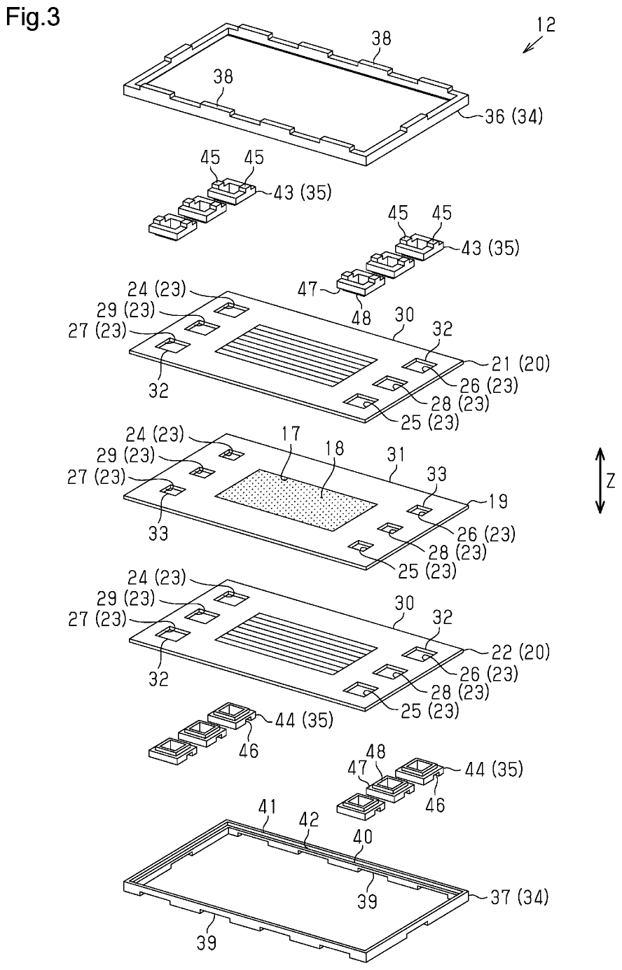

As shown in FIGS. 2 and 3, the cell 12 includes a plastic support frame member 19 and two metal separators 20. The support frame member 19 supports a membrane electrode assembly (MEA) 18 at a central portion of the support frame member 19. The separators 20 sandwich the support frame member 19 that supports the membrane electrode assembly 18. Specifically, the support frame member 19 supports the membrane electrode assembly 18, having a rectangular sheet shape, in a rectangular opening 17 at the central portion. One of the two separators 20 is a first separator 21, and the other one is a second separator 22.

When a portion of the membrane electrode assembly 18 at one end (anode side) in the stacking direction Z is supplied with fuel gas and a portion of the membrane electrode assembly 18 at the other end (cathode side) is supplied with oxidant gas, each cell 12 generates power from an electrochemical reaction of the fuel gas and the oxidant gas in the membrane electrode assembly 18. The opposite ends of the cell 12 in the longitudinal direction, that is, the opposite ends of the support frame member 19, the first separator 21, and the second separator 22 in the longitudinal direction, each have multiple (six in this example) through-holes 23. For example, each through-hole 23 is quadrilateral.

These six through-holes 23 are referred to as a fuel gas supply hole 24, a fuel gas discharge hole 25, an oxidant gas supply hole 26, an oxidant gas discharge hole 27, a cooling medium supply hole 28, and a cooling medium discharge hole 29. The fuel gas supply hole 24 defines a passage which extends in the stacking direction Z and to which fuel gas, which is an example of fluid, is supplied. The fuel gas discharge hole 25 defines a passage which extends in the stacking direction Z and from which fuel gas is discharged.

The oxidant gas supply hole 26 defines a passage which extends in the stacking direction Z and to which oxidant gas, which is an example of fluid, is supplied. The oxidant gas discharge hole 27 defines a passage which extends in the stacking direction Z and from which oxidant gas is discharged. The cooling medium supply hole 28 defines a passage which extends in the stacking direction Z and to which coolant, which is an example of fluid, is supplied. The cooling medium discharge hole 29 defines a passage which extends in the stacking direction Z and from which coolant is discharged.

### Support Frame Member 19

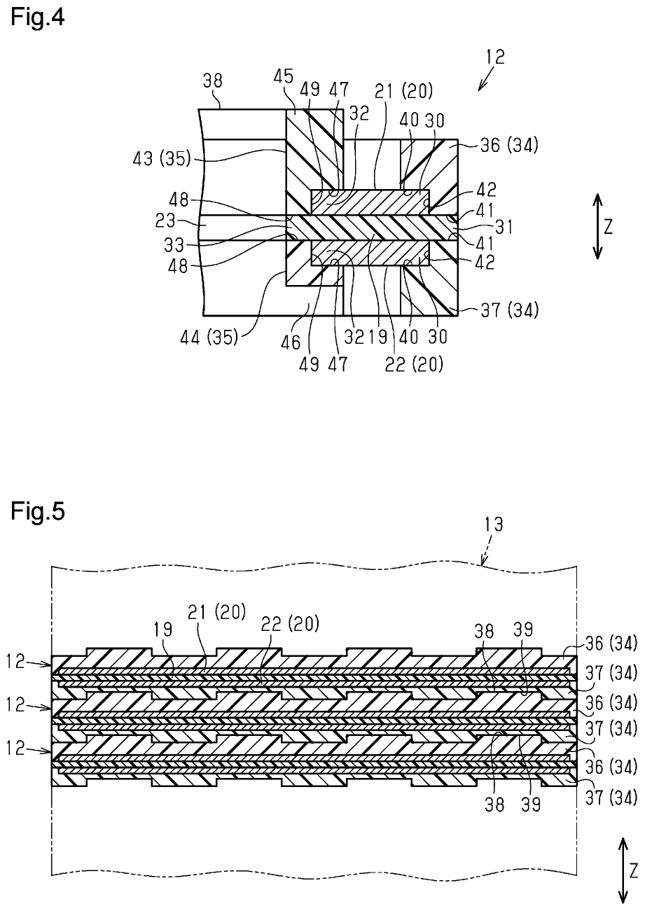

As shown in FIGS. 3 and 4, the support frame member 19 is a rectangular plate that is slightly larger than each separator 20. Thus, the outer edge of the support frame member 19 protrudes outward from the outer edge 30 of the separator 20. The rectangular frame of the outer edge of the support frame member 19 protruding outward from the outer edge 30 of the separator 20 is an outer edge protrusion 31, which is an example of a protrusion.

The through-holes 23 in the support frame member 19 have a quadrilateral shape slightly smaller than the through-holes 23 in the separator 20. Thus, the peripheral edges of the through-holes 23 in the support frame member 19 respectively protrude inward from the peripheral edges 32 of the through-holes 23 in the separator 20. The quadrilateral frame of the peripheral edge of each through-hole 23 of the support frame member 19 protruding inward from the peripheral edge 32 of a corresponding through-hole 23 of the separator 20 is a peripheral edge protrusion 33, which is an example of a protrusion. Accordingly, the support frame member 19 of the present example includes six peripheral edge protrusions 33.

The outer edge protrusion 31 of the support frame member 19 is sandwiched by two rectangular loop outer edge frames 34, which are examples of plastic frames, in the stacking direction Z together with the outer edges 30 of the two separators 20. The two outer edge frames 34 are joined to the outer edge protrusion 31 of the support frame member 19 and the outer edges 30 of the two separators 20, for example, using adhesive or through thermal welding.

The peripheral edge protrusions 33 of the support frame member 19 are each sandwiched by two quadrilateral loop peripheral edge frames 35, which are examples of the plastic frames, in the stacking direction Z together with the peripheral edges 32 of the through-holes 23 of the two separators 20. That is, six peripheral edge protrusions 33 of the support frame member 19 are respectively sandwiched by six pairs of peripheral edge frames 35 in the stacking direction Z together with the peripheral edges 32 of the six through-holes 23 of the two separators 20. Each pair of peripheral edge frames 35 is joined to a corresponding peripheral edge protrusion 33 of the support frame member 19 and the peripheral edge 32 of a corresponding through-hole 23 of each of the two separators 20, for example, using adhesive or through thermal welding.

### Outer Edge Frame 34

As shown in FIGS. 3 and 4, one of the two outer edge frames 34 is referred to as a first outer edge frame 36, and the other one is referred to as a second outer edge frame 37. One of the two outer surfaces of each pair of outer edge frames 34 in the stacking direction Z includes multiple (ten in the present example) outer edge projections 38, which are examples of protrusions. The other one includes multiple (ten in the present example) outer edge recesses 39, which are examples of recesses.

In other words, the outer edge projections 38 are provided along the outer surface of the first outer edge frame 36, in the stacking direction Z, so as to be arranged over the full perimeter of the first outer edge frame 36. Further, the outer edge recesses 39 are provided along the outer surface of the second outer edge frame 37, in the stacking direction Z, so as to be arranged over the full perimeter of the second outer edge frame 37.

As shown in FIG. 5, the outer edge projections 38 of the first outer edge frame 36 on one of the two adjacent cells 12 in the stacked state are configured to be respectively fitted into the outer edge recesses 39 of the second outer edge frame 37 on the other one.

As shown in FIG. 4, the inner surface of the first outer edge frame 36 in the stacking direction Z includes an inner contact surface 40 in contact with the outer edge 30 of the first separator 21 and an outer contact surface 41 in contact with the outer edge protrusion 31 of the support frame member 19. A step 42 is formed between the inner contact surface 40 and the outer contact surface 41.

The inner surface of the second outer edge frame 37 in the stacking direction Z includes an inner contact surface 40 in contact with the outer edge 30 of the second separator 22 and an outer contact surface 41 in contact with the outer edge protrusion 31 of the support frame member 19. A step 42 is formed between the inner contact surface 40 and the outer contact surface 41.

### Peripheral Edge Frame 35

As shown in FIGS. 3 and 4, for each pair of peripheral edge frames 35, one is referred to as a first peripheral edge frame 43, and the other one is referred to as a second peripheral edge frame 44. That is, a pair of peripheral edge frames 35 include one first peripheral edge frame 43 and one second peripheral edge frame 44.

One of the two outer surfaces of each pair of peripheral edge frames 35 in the stacking direction Z includes multiple (two in the present example) peripheral edge projections 45, which are examples of protrusions. The other one includes multiple (two in the present example) peripheral edge recesses 46, which are examples of recesses.

In other words, the peripheral edge projections 45 are arranged on the outer surface of each first peripheral edge frame 43 in the stacking direction Z. and the peripheral edge recesses 46 are arranged on the outer surface of a corresponding second peripheral edge frame 44 in the stacking direction Z. Further, the first peripheral edge projections 45 of each first peripheral edge frame 43 on one of two adjacent cells 12 in the stacked state are configured to be respectively fitted into the second peripheral edge recesses 46 of a corresponding second peripheral edge frame 44 on the other one.

The inner surface of the first peripheral edge frame 43 in the stacking direction Z includes an outer contact surface 47 in contact with the peripheral edge 32 of the through-hole 23 of the first separator 21 and an inner contact surface 48 in contact with the peripheral edge protrusion 33 of the support frame member 19. A step 49 is formed between the outer contact surface 47 and the inner contact surface 48.

The inner surface of the second peripheral edge frame 44 in the stacking direction Z includes an outer contact surface 47 in contact with the peripheral edge 32 of the through-hole 23 of the second separator 22 and an inner contact surface 48 in contact with the peripheral edge protrusion 33 of the support frame member 19. A step 49 is formed between the outer contact surface 47 and the inner contact surface 48.

### Operation of Embodiment

In each cell 12, its outer edge is sandwiched by a pair of outer edge frames 34, and the peripheral edges of the six through-holes 23 are respectively sandwiched by six pairs of the peripheral edge frames 35. Thus, the cells 12 are effectively reinforced. This increases the rigidity of each cell 12 and thus limits warping of the cell 12.

When the cells 12 are stacked, the outer edge projections 38 of the first outer edge frame 36 on one of the two adjacent cells 12 in the stacked state are respectively fitted into the outer edge recesses 39 of the second outer edge frame 37 on the other one. In addition, the first peripheral edge projections 45 of each first peripheral edge frames 43 on one of the two adjacent cells 12 in the stacked state are respectively fitted into the second peripheral edge recesses 46 of a corresponding second peripheral edge frame 44 on the other one.

This allows the cells 12 to be readily stacked with high accuracy in the stacking direction Z so that the cells 12 are stable in the stacked state. This improves the quality of the fuel cell stack 13.

### Advantages of Embodiment

The embodiment described above in detail has the following advantages.

(1) In the fuel cell stack 13, the outer edge of each cell 12 is sandwiched by a pair of outer edge frames 34, and the peripheral edges of six through-holes 23 are respectively sandwiched by six pairs of the peripheral edge frames 35.

This configuration allows a pair of outer edge frames 34 and six pairs of the peripheral edge frames 35 to effectively reinforce each cell 12. This increases the rigidity of each cell 12 and thus limits warping of the cell 12. This stabilizes the cells 12 in the stacked state.

(2) In the fuel cell stack 13, the outer edge projections 38 of the first outer edge frame 36 on one of two adjacent cells 12 in the stacked state are respectively fitted into the outer edge recesses 39 of the second outer edge frame 37 on the other one. In addition, the first peripheral edge projections 45 of each of the first peripheral edge frames 43 on one of the two adjacent cells 12 in the stacked state are respectively fitted into the second peripheral edge recesses 46 of a corresponding second peripheral edge frame 44 on the other one.

This configuration prevents two stacked adjacent cells 12 from being displaced from each other in the direction orthogonal to the stacking direction Z. This allows the cells 12 to be readily stacked with high accuracy in the stacking direction Z so that the cells 12 are more stable in the stacked state. This improves the quality of the fuel cell stack 13.

### Modifications

The above embodiment may be modified as follows. The above embodiment and the following modifications can be combined as long as the combined modifications remain technically consistent with each other.

The outer edge projections 38 of the first outer edge frame 36 and the outer edge recesses 39 of the second outer edge frame 37 may be omitted.

The number of outer edge projections 38 of the first outer edge frame 36 and the number of outer edge recesses 39 of the second outer edge frame 37 do not necessarily need to match each other. That is, the number of outer edge projections 38 and the number of outer edge recesses 39 may be different from each other. In other words, there may be outer edge projections 38 or outer edge recesses 39 that are not fitted together between two adjacent stacked cells 12.

The peripheral edge projections 45 of each first peripheral edge frame 43 and the peripheral edge recesses 46 of a corresponding second peripheral edge frame 44 may be omitted.

The number of peripheral edge projections 45 of the first peripheral edge frame 43 does not necessarily need to match the number of peripheral edge recesses 46 of the second peripheral edge frame 44. That is, the number of peripheral edge projections 45 may differ from the number of peripheral edge recesses 46. In other words, there may be peripheral edge projections 45 or peripheral edge recesses 46 that are not fitted together between two adjacent stacked cells 12.

The six pairs of peripheral edge frames 35 may be omitted. In this case, it is preferred that the peripheral edge protrusions 33 corresponding to the six pairs of peripheral edge frames 35 be omitted.

The pair of outer edge frames 34 may be omitted. In this case, it is preferred that the outer edge protrusion 31 corresponding to the pair of outer edge frames 34 be omitted.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A fuel cell stack, comprising stacked cells, wherein
each of the cells includes:
a plastic support frame member that supports a membrane electrode assembly at a central portion of the support frame member; and
two separators that sandwich the support frame member,
the support frame member and the two separators each have a through-hole that defines a passage through which fluid flows, the passage extending in a stacking direction of the cells,
the support frame member includes a protrusion that protrudes from each of the separators in at least one of an outer edge of the support frame member and a peripheral edge of the through-hole of the support frame member, and
the protrusion is sandwiched by plastic frames in the stacking direction together with outer edges of the separators, peripheral edges of the through-holes of the separators, or both the outer edges and the peripheral edges.

2. The fuel cell stack according to claim 1, wherein
one of two outer surfaces of the plastic frames sandwiching the protrusion in the stacking direction includes a projection, and the other one of the two outer surfaces includes a recess, and
the projection of the plastic frame included in one of two adjacent ones of the stacked cells is fitted to the recess of the plastic frame included in the other one of the two adjacent stacked cells.
